(19) United States
(12) Patent Application Publication
(10) Pub. No.: US 2016/0048924 A1
(43) Pub. Date: Feb. 18, 2016

(54) METHOD AND SYSTEM FOR THE CREATION AND DELIVERY TO A USER OF AN AUTOMATED, REAL TIME, ONLINE INSURANCE POLICY AND CERTIFICATE OF INSURANCE FOR RENTAL OF A VENUE AND/OR EQUIPMENT

(71) Applicants: Craig Arnatt, Vancouver (CA); Peter Parkin, Bowen Island (CA)

(72) Inventors: Craig Arnatt, Vancouver (CA); Peter Parkin, Bowen Island (CA)

(21) Appl. No.: 14/924,665

(22) Filed: Oct. 27, 2015

Related U.S. Application Data
(63) Continuation of application No. 14/093,355, filed on Nov. 29, 2013.
(60) Provisional application No. 61/730,791, filed on Nov. 28, 2012.

(51) Int. Cl. G06Q 40/08

(52) U.S. Cl. CPC G06Q 40/08

(57) ABSTRACT

A method of furnishing a real-time, self-binding, on-line bound policy for a venue and rental equipment insurance product for a user of such a venue, comprises presenting to the user, via an electronic interface, prompted questions relating to venue and location, and at least one of activity to be undertaken at venue and duration of activity; receiving at a computing device, user answers to the prompted questions; searching attributes of the venue in a base data relating to said venue; receiving rating information from a rating engine relating to at least one of: venue and location, activity to be undertaken at venue, duration of activity and maximum benefits payable upon the occurrence of an insured event (limit selection); and using base data and rating information to calculate insurance terms, an insurance quote and to create, issue electronically transmit insurance policy and certificate of insurance to a computing device of user.

### CROSS-REFERENCE TO RELATED APPLICATIONS

This application is a Continuation of U.S. patent application Ser. No. 14/093,355, filed Nov. 29, 2013, which claims the benefit of U.S. Provisional Application No. 61/730,791, filed Nov. 28, 2012, which are expressly incorporated herein by reference in their entirety for all purposes.

### FIELD OF THE INVENTION

This invention relates to the field of online, real time systems for insurance transactions.

### BACKGROUND OF THE INVENTION

The basic concept behind purchasing insurance is transfer of risk.

Some electronic systems and Internet web-sites may be utilized to facilitate insurance transactions. For example, a user may use the Internet to access a web-site of a particular insurance company, and to submit online a request for a quote for insuring a pre-defined risk, e.g., a risk associated with a vehicle or a home of the user. The user may be required to enter various personal details associated with the user (e.g., age, gender, marital status, or the like), as well as various details associated with the risk for which insurance coverage is sought (e.g., make and model of the vehicle, year of manufacture of the vehicle, or the like).

In some systems, an agent of the insurance company may manually review the data entered by the user and may manually calculate an insurance quote. In other systems, a pre-defined algorithm may be used to automatically calculate the insurance quote based on the data entered by the user. After the insurance quote is calculated (manually or automatically), the insurance company may provide to the user the insurance quote (e.g., premium amount, coverage amount, and other terms) through the electronic system. These systems are by no means “self-binding” policies due to the requisite “back and forth” interaction between the user and the insurance company.

Special event insurance is an umbrella term for policies that cover public assembly, whether at a corporate or personal party, a trade show, sports tournaments or a seminar or the like. The coverage is often purchased because of contractual requirements from a venue and often covers general liability insurance, which offers protection against lawsuits stemming from personal injury and property damage, and can cover anything from trips and falls to food poisoning.

Equipment Rental Insurance is an umbrella term for policies that cover the user of rented equipment let by an equipment rental business. The coverage is often purchased because of contractual requirements from the rental business and covers loss or damage to the equipment.

With regards to the temporary access and use of municipal venues and privately owned facilities, users/hosts of events at such venues who are required to purchase insurance policies for a selected venue, activity and duration are asked to provide the facility owner with acceptable evidence of insurance by way of an insurance certificate containing specific limits, named insureds, additional insureds, terms and conditions. The insurance industry provides limited access to brokers who carry such polices thereby creating a significant inconvenience and potential for errors purchasing incorrect limits of coverage and or errors in recording the requirement of additional named insured parties by the venue or facility user.

With regards to the temporary insurance for users of rented equipment from equipment rental dealers at specific venues, users of such equipment rental venues who are required to purchase insurance policies for the rented equipment who are asked to provide the facility owner with acceptable evidence of insurance by way of an insurance certificate containing specific replacement cost limits, loss payee, terms and conditions. The insurance industry provides limited access to brokers who carry such polices thereby creating a significant inconvenience and potential for errors purchasing incorrect replacement cost limits of coverage and or errors in loss payees by the renter or equipment user.

Hence, there is a need for a method and system that is not inconvenient, time consuming and burdensome that affords the consumer with venue or event insurance and equipment insurance and the ability to complete the transaction with speed, accuracy and convenience. It is an object of the present invention to obviate or mitigate all of the above disadvantages.

### SUMMARY OF THE INVENTION

The present invention provides, in one aspect, a method of furnishing a real-time, self-binding, on-line bound policy for a venue insurance product for a user of such a venue, comprising:
a) presenting to the user, via an electronic interface, prompted questions relating to venue and location, and at least one of activity to be undertaken at venue and duration of activity;
b) receiving from the user at a computing device, answers to the prompted questions;
c) searching attributes of the venue in a base data relating to said venue;
d) receiving rating information from a rating engine relating to at least one of: venue and location, activity to be undertaken at venue, duration of activity and maximum benefits payable upon the occurrence of an insured event (limit selection); and
e) using base data and rating information to calculate insurance terms, an insurance quote and to create and issue insurance policy and Certificate of Insurance for the user, all without interaction with an insurance company agent or representative.

In a further aspect, the present invention provides a method for furnishing a real-time, self-binding, on-line bound property policy for an equipment rental dealer for a user of such equipment, comprising:
a) presenting to the user, via an electronic interface, prompted questions relating to rented equipment and usage of equipment from a specified location, and at least one of activity to be undertaken with the equipment and duration of use;
b) receiving from the user at a computing device, answers to the prompted questions;
c) searching attributes of the equipment type to form base data relating to said equipment;
d) receiving rating information from a rating engine relating to at least one of: type of equipment, location of the equipment, activity to be undertaken with the equipment, duration of rental contract and maximum benefits payable upon the occurrence of an insured peril (replacement cost); and
e) using base data and rating information to calculate insurance terms, an insurance quote and to create and issue insurance policy and Certificate of Insurance for the user, all without interaction with an insurance company agent or representative.

In a further aspect, the present invention provides a system for creating a self-binding insurance policy for a user of a desired venue which comprises:
a) an electronic interface for the user;
b) a server for presenting to the user, via the electronic interface, prompted questions relating to desired venue and location, and at least one of activity to be undertaken at desired venue and duration of activity and to receive answers to the prompted questions;
c) a searchable base data store;
d) a searching means to search attributes of the desired venue in the data store; and
e) a processor to receive information from a rating engine relating to at least one of: desired venue and location, activity to be undertaken at desired venue, duration of activity and maximum benefits payable upon the occurrence of an insured event (limit selection) and i) to calculate, using the base data and rating information, i) a quote for an insurance policy and ii) insurance terms thereby to create and issue insurance policy and Certificate of Insurance for the user, both i) and ii) without interaction with an insurance agent or customer service representative (CSR).

In a further aspect, the present invention provides a system for creating a self-binding insurance policy for a user of equipment which comprises:
a) an electronic interface for the user;
b) a server for presenting to the user, via the electronic interface, prompted questions relating to rented equipment and usage of equipment from a specified location, and at least one of activity to be undertaken with the equipment and duration of use, to receive answers to the prompted questions;
c) a searchable base data store;
d) a searching means to search attributes of the equipment in the data store;
e) a processor to receive information from a rating engine relating to at least one of: type of equipment, location of the equipment, activity to be undertaken with the equipment, duration of rental contract and maximum benefits payable upon the occurrence of an insured peril (replacement cost); and to calculate, using the base data and rating information, i) a quote for an insurance policy and Certificate of Insurance and ii) insurance terms thereby to create and issue insurance policy for the user, both i) and ii) without interaction with an insurance agent or customer service representative (CSR).

In a further aspect, the present invention provides a computer readable medium including at least computer program code for enabling the creation of a secure online, self-binding insurance policy for a user to use a venue, said computer readable medium comprising computer program code for presenting to the user, via an electronic interface, prompted questions relating to venue and location, and at least one of activity to be undertaken at venue and duration of activity; computer program code for receiving from the user at a computing device, answers to the prompted questions; computer program code for searching attributes of the venue to form base data relating to said venue; and computer program code for receiving rating information from a rating engine relating to at least one of: venue and location, activity to be undertaken at venue, duration of activity and maximum benefits payable upon the occurrence of an insured event (limit of insurance selection).

In a further aspect, the present invention provides a computer readable medium including at least computer program code for enabling the creation of a secure online, self-binding insurance policy for a user to rent equipment, said computer readable medium comprising computer program code for presenting to the user, via an electronic interface, prompted questions relating to rented equipment and usage of equipment from a specified location, and at least one of activity to be undertaken with the equipment and duration of use; computer program code for receiving from the user at a computing device, answers to the prompted questions; computer program code for searching attributes of the equipment type to form base data relating to said equipment; and computer program code for receiving rating information from a rating engine relating to at least one of: type of equipment, location of the equipment, activity to be undertaken with the equipment, duration of rental contract and maximum benefits payable upon the occurrence of an insured peril (replacement cost).

The present application provides, in another aspect, a computer implemented method of preparing for a user a real-time, on-line bound policy for a venue comprising: presenting to the user, by an on-line self-binding system application providing computer executable instructions executed by a computer including a) receiving from the user at a computing device answers to questions relating to at least one of the venue to be insured, by the on-line binding system application via an on-line system web server, wherein said answers to the questions comprises information selected from the group consisting of: venue and location, activity to be occurring at venue, duration of activity, effective date of policy, and expiry of policy (“attributes”), searching attributes in a database, receiving rating information from a rating engine relating to at least one of: desired venue and location, activity to be undertaken at desired venue, duration of activity and maximum benefits payable upon the occurrence of an insured event (limit selection) and calculating, using the rating information, i) a quote for an insurance policy and ii) insurance terms thereby to create and issue insurance policy and Certificate of Insurance for the user, both i) and ii) without interaction with an insurance agent or customer service representative (CSR).

The present application provides, in another aspect, a computer implemented method of preparing for a user a real-time, on-line bound policy for an equipment, at a venue comprising: presenting to the user, by an on-line self-binding system application providing computer executable instructions executed by a computer including a) receiving from the user at a computing device answers to questions relating to equipment to be insured, by the on-line binding system application via an on-line system web server, wherein said answers to the questions comprises information selected from the group consisting of: type of equipment, activity to be performed using equipment, venue and location, duration of equipment use, effective date of policy, and expiry of policy (“attributes”), searching attributes in a database, receiving rating information from a rating engine relating to at least one of: equipment type, activity, duration of use of equipment and maximum benefits payable upon the occurrence of an insured event (limit selection) and calculating, using the rating information, i) a quote for an insurance policy and Certificate of Insurance and ii) insurance terms thereby to create and issue insurance policy for the user, both i) and ii) without interaction with an insurance agent or customer service representative (CSR).

The present application provides, in another aspect, a user interface on user's computing device which enables communication with an on-line binding system application through an internet, intranet or cloud based web server.

The system, computer medium, and method of the present invention creates a new, efficient way to deliver a self-binding insurance policy to a user of a venue or for an event or renter of equipment for a particular use or purpose. This is not simply the delivery of a quotation online but rather an entire bound policy, said policy created by the intelligent use of and weighting of user entered information, stored data on the venue and/or equipment and ratings information related to one or more of (as appropriate): the activity to the conducted at the venue, the duration of the activity, the rented equipment and usage of equipment from a specified location, and at least one of activity to be undertaken with the equipment and duration of use and other limit selections. The use of a method and system which automatically weights and creates hierarchies around both venue and/or equipment data and ratings information, in order to underwrite, rate, quote and bind a policy, and to deliver online a Certificate of Insurance has not been previously achieved.

These and other advantages of the invention will become apparent throughout the present disclosure.

### BRIEF DESCRIPTION OF THE FIGURES

For simplicity and clarity of illustration, reference numerals may be repeated among the figures to indicate corresponding or analogous elements. The figures are listed below.

FIG. 1 is a schematic block flow diagram of a method in accordance with some demonstrative embodiments of the invention;

FIG. 2 is a schematic block flow diagram of a system in accordance with some demonstrative embodiments of the invention;

FIG. 3 is a sample of a Certificate of Insurance for a venue rental;

FIG. 4 is a sample of a Certificate of Insurance for equipment rental; and

FIG. 5A and FIG. 5B are another sample of a Certificate of Insurance for a venue rental.

### DETAILED DESCRIPTION OF THE INVENTION

There is provided herein a method, system and apparatus/device for computer based insurance processing and more specifically for the integration of a process to maintain and administer the insurance requirements for users of, preferably, government and privately owned venues, facilities and equipment in a real-time, on-line process.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Unless specifically stated otherwise, it is appreciated that throughout the description, discussions utilizing terms such as “processing” or “computing” or “calculating” or “determining” or “displaying” or the like, refer to the action and processes of a data processing system, or similar electronic computing device, that manipulates and transforms data represented as physical (electronic) quantities within the computer system's registers and memories into other data similarly represented as physical quantities within the computer system memories or registers or other such information storage, transmission or display devices.

Any algorithms and displays with the applications described herein are not inherently related to any particular computer or other apparatus. Various general-purpose systems may be used with programs in accordance with the teachings herein, or it may prove convenient to construct more specialized apparatus to perform the required machine-implemented method operations. The required structure for a variety of these systems will appear from the description below. In addition, embodiments of the present invention are not described with reference to any particular programming language. It will be appreciated that a variety of programming languages may be used to implement the teachings of embodiments of the invention as described herein.

An embodiment of the invention may be implemented as a method or as a machine readable non-transitory storage medium that stores executable instructions that, when executed by a data processing system, causes the system to perform a method. An apparatus, such as a data processing system, can also be an embodiment of the invention. Other features of the present invention will be apparent from the accompanying drawings and from the detailed description which follows.

The term “invention” and the like mean “the one or more inventions disclosed in this application”, unless expressly specified otherwise.

The terms “an aspect”, “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not all) embodiments of the disclosed invention(s)”, unless expressly specified otherwise.

The term “device” and “mobile device” refer herein to any personal digital assistants, Smart phones, other cell phones, tablets and the like.

The term “variation” of an invention means an embodiment of the invention, unless expressly specified otherwise. A reference to “another embodiment” or “another aspect” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “plurality” means “two or more”, unless expressly specified otherwise.

The term “herein” means “in the present application, including anything which may be incorporated by reference”, unless expressly specified otherwise.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “e.g.” and like terms mean “for example”, and thus does not limit the term or phrase it explains. For example, in a sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “respective” and like terms mean “taken individually”. Thus if two or more things have “respective” characteristics, then each such thing has its own characteristic, and these characteristics can be different from each other but need not be. For example, the phrase “each of two machines has a respective function” means that the first such machine has a function and the second such machine has a function as well. The function of the first machine may or may not be the same as the function of the second machine.

The term “i.e.” and like terms mean “that is”, and thus limits the term or phrase it explains. For example, in the sentence “the computer sends data (i.e., instructions) over the Internet”, the term “i.e.” explains that “instructions” are the “data” that the computer sends over the Internet.

The term “events” includes, but is not limited to, festivals, concerts, exhibition centres, trade shows, sporting events, art shows, conferences, seminars, employee parties, wedding and other celebratory or memorial venues and virtually any other type of event. Many venues require a user to provide proof of minimum levels of event insurance when the venue is booked. A user may need to purchase additional event insurance even if it is held as a special one-day event at the user's own facility, because this activity may not be covered by the user's current business insurance policy. Accordingly, venue or event insurance is not to be overlooked.

As used herein, a “venue” includes, but is not limited to any place accommodating an event, as defined above.

The term “equipment” includes, without limitation, all goods, chattels, machinery, apparatus, gear, tools, vehicles, materials, outfit, paraphernalia of whatever kind, size or type that may be sought to be rented by a user, for use in any venue.

In many aspects, a user would seek to rent a venue, for an event and would concomitantly rent equipment to support such an event. In some aspects, an owner or controller of the desired venue may also own/control the desired equipment. Within the scope of the invention, a user may wish to rent the desired venue for a duration of time and for a specific purpose or activity. Within the scope of the invention, a user may wish to rent the desired equipment for a duration of time and for a specific purpose or activity.

As used herein, a “Certificate of Insurance” refers to an electronic document which certifies that an insurance policy has been bought by a user and shows an abstract of the most important provisions of the insurance contract (the policy), as agreed to by the user using the online method and system of the invention.

It is an object of the present invention to provide a unitary method and system for underwriting, rating, quoting, binding a policy and issuing an insurance certificate for a venue and/or equipment, preferably for a short term or recurrent event at said venue and/or with regard to said equipment.

It is an object of the present invention to provide an interactive, real time communications system for a user in need of insurance for an event or equipment rental at a venue, said system interacting with an internet or intranet browser thereby providing a means to parse key information regarding the venue or facility and/or equipment with the user as a Named Insured including one or more the following: the venue or facility's requirement for the insurance policy to list specific Additional Insureds or Loss Payee, the venue or facility's requirement for the insurance policy to list a Minimum Limit of Insurance, the venue or facility's requirement for the insurance policy to list approved Activities and the Duration of these activities, the venue or facility's requirement for the insurance policy to list the Effective Date and the Expiry Date of the policy, and the owner/controller of the equipment's analogous insurance requirements and such evidence which may be required to show acceptable Carriers of Insurance.

It is an object of the present invention to provide, following completion of processing, the results as an electronic document of insurance referred to herein as a Certificate of Insurance, which is made available via electronic delivery as well as retrievable through the user's on-line document storage system so as to provide the user of municipal venues and privately owned facilities sufficient evidence that insurance is in effect during and for the user's activities while occupying (preferably) government (for example federal or provincial or municipal) venues and privately owned facilities.

It is an object of the present invention to provide, following completion of processing, the results as an electronic document of insurance referred to as a Certificate of Insurance, which is made available via electronic delivery as well as retrievable through the user's on-line document storage system so as to provide the user of equipment sufficient evidence that insurance is in effect during and for the user's activities while using the equipment.

The present invention provides, in a preferred aspect, computer-based insurance processing and more specifically the integration of venue specific insurance requirements of municipal venues and privately owned facilities. In one aspect of the invention a computer system to perform the process of underwriting, rating, quoting, binding, policy issuance and insurance certificate delivery comprises of one or more browser operative to communicate the specific venue or facility insurance requirement information that the user is occupying to a dispatcher that parses the information to determine key information regarding; the venue or facility user as a Named Insured, the venue or facility's requirement for the insurance policy to list specific Additional Insureds, the venue or facility's requirement for the insurance policy to list a Minimum Limit of Insurance, the venue or facility's requirement for the insurance policy to list approved Activities and the Duration of these activities, the venue or facility's requirement for the insurance policy to list the Effective Date and the Expiry Date of the policy, and such evidence to show acceptable Carriers of Insurance. Following completion of the processing the results are provided as an electronic document of insurance referred to as a Certificate of Insurance, which is made available via electronic delivery as well as retrievable through the user's on-line document storage system so as to provide the user of municipal venues and privately owned facilities sufficient evidence that insurance is in effect during and for the user's activities while occupying municipal venues and privately owned facilities.

Specifically, the present invention provides a method of furnishing a real-time, self-binding, on-line bound policy for a venue insurance product for a user of such a venue, comprising:
a) presenting to the user, via an electronic interface, prompted questions relating to venue and location, and at least one of activity to be undertaken at venue and duration of activity;
b) receiving from the user at a computing device, answers to the prompted questions;
c) searching attributes of the venue to form base data relating to said venue;
d) receiving rating information from a rating engine relating to at least one of: venue and location, activity to be undertaken at venue, duration of activity and maximum benefits payable upon the occurrence of an insured event (limit selection);
e) using base data and rating information to provide the user with a quote for the policy, to calculate insurance terms and to create and issue insurance policy and Certificate of Insurance for the user without interaction with any insurance company representative.

Preferably, the base data is stored information relating to previous usages of venue by user. Preferably, base data is stored information relating to previous usages of venue by other users. Preferably, the limit selection is stored in a collective database relating to said venue. Preferably, the venue is selected from the group consisting of halls, arenas, auditoriums, lecture halls, theatres, vendor exhibition spaces, trade shows, restaurants, houses, condominiums, tourists attractions, sporting event venues, art show venues, amusement parks, and conference halls. Preferably, user consents to online payment for the policy and secures such payment online. Preferably such a method comprises searching a venue selection module most preferably searching via keywords or geographic/geolocation cues.

A system represents one embodiment of the present invention and utilizes, for example, a web-based application, which, has in one aspect, four primary components, including a i) front end or presentation layer which is responsible for the delivery and formatting of information to the ii) application layer for further processing or display at a user interface. The presentation layer may be developed using, for example, Cold Fusion, and run on a web application server. The web application server communicates with iii) venue/equipment database and the iv) rating engine server (s) as described further herein. The site accommodates a number of browsers and versions of those browsers, such as, for example, Internet Explorer 3.0.2 or greater, Netscape Communicator 3.x or greater, and all AOL browsers 3.x or greater.

In a system of the invention comprising a searching means, such searching means preferably comprises one or both of i) a venue selection module and ii) an equipment selection module. Preferably, searching means comprises a venue selection module which comprises a database of a plurality of venue activities permitted at such venues and duration of time activities are permitted at such venues.

Preferably, searching means comprises a venue selection module which comprises a database of a plurality of venues and, among other information: activities permitted at such venues and duration of time activities are permitted at such venues. Preferably, the venue selection module is used to identify/locate the desired venue by at least one of keyword, geographic or geolocation searching. Preferably, venue selection module comprises a database of venues through which the desired venue may be located and identified and through which insurance-relevant data related to the desired venue may be appropriated. Preferably insurance-relevant data, relevant to a venue, comprises additional insured requirements, loss history, activities allowed at venue, license agreements to which venue or user bound, square footage, capacity, alcohol licensing, minimum indemnity and limits.

Preferably, searching means comprises an equipment selection module which comprises a database of a plurality of equipment and, among other information: features, uses of, characteristics, and location of the equipment and through which equipment can be searched. Preferably, the equipment selection module is used to identify and/or locate the desired equipment by at least one of keyword, geographic or geolocation searching. Preferably, the equipment selection module comprises a database of equipment through which the desired equipment may be located and identified and through which insurance-relevant data related to the desired equipment may be appropriated. Preferably insurance-relevant data, relevant to equipment comprises equipment type and replacement values.

Searching means comprises an equipment selection module through which the desired equipment is located by at least one of features, characteristics and geographic search.

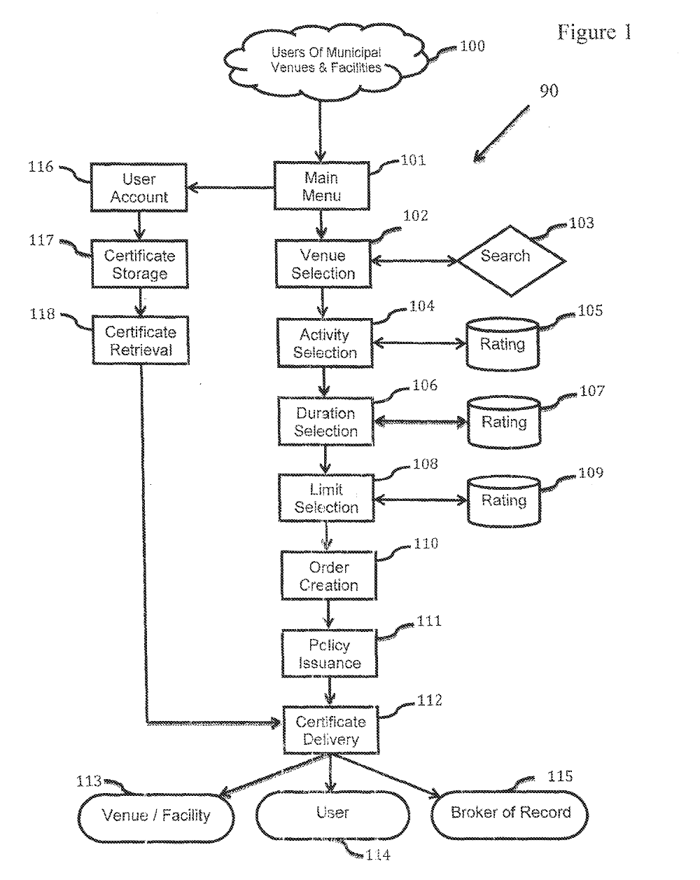

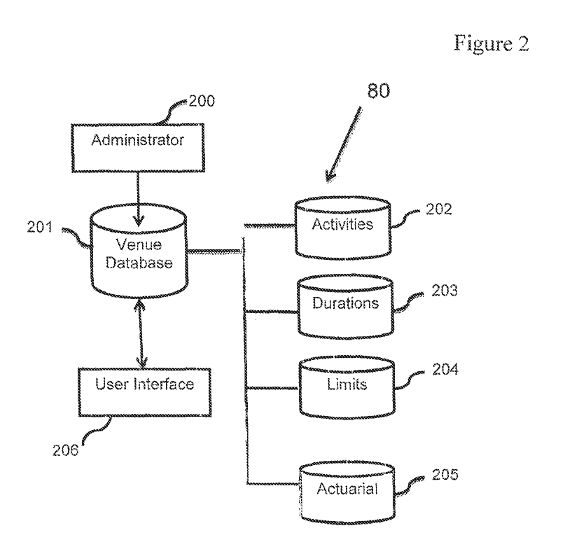

FIG. 1 is a schematic diagram which provides further detail regarding key components and the flow of information between key components of the method/system for an embodiment of the present invention. FIG. 2 illustrates a block diagram of an insurance system 80 to facilitate creation of a self-binding insurance coverage product in accordance with some embodiments on the invention. The insurance system 80, associated database 201 and user interface 206 may therefore facilitate the creation of insurance coverage policies by a user.

In operation, and with reference to FIGS. 1 and 2, there is provided generally at 90 an insurance method. Users of municipal venues and privately owned facilities are shown at 100. Such users are required to purchase insurance policies whilst utilizing a venue or publicly/privately owned facility, and are asked to provide the facility owner with acceptable evidence of insurance by way of an insurance certificate comprising specific limits, named insureds, additional insureds, terms and conditions.

User 100 interfaces via internet browser a computer system to perform the process of underwriting, rating, quoting, binding, policy issuance and insurance certificate delivery. Such users are seeking to rent or otherwise “use”, for example, municipal venues and privately owned facilities and are required to purchase insurance policies whilst utilizing such municipal venue or privately owned facility. Users are asked to provide the facility owner with acceptable evidence of insurance by way of an insurance certificate containing specific limits, named insured, additional insured, terms and conditions. The user interfaces with an application via an internet browser on a computing device to perform the process of acquiring a self-binding insurance policy via the steps of: underwriting, rating, quoting, binding, policy issuance and insurance certificate delivery.

User 100 is provided with a main menu 101 on an interface wherein the system's main options are presented via a web browser. User 100 is thereby presented with options and selects actions. Such actions are to be routed to either user account interface 116, where historical data or insurance certificate purchases can be reviewed and analyzed or actions and routed or to the main menu 101 of the venue selection routine where a new insurance policy certificate is generated by way of a policy creation. So, main menu 101 simply illustrates the system's main options presented via web browser where by the interface presents the user with options and determines actions.

Block 102 represents the “venue selection” step wherein a user, via an interface enters at least some venue information/co-ordinates such that a venue lookup is initiated via locative information choices such as, for example, country, province, city and neighborhood to which matching lists of data pertaining to municipal venues and privately owned facilities stored in the system's venue data base tables are displayed. The Venue Selection is one key element of the present invention whereby the loading of essential data relating to the venue or facility is carried forward during the workflow processes to allow for the creation of venue specific insurance policy and related certificate of insurance.

Block 103 represents a search step, wherein the system uses an integrated method of displaying retrieved key locative information of a venue or facility whereby user input is entered into a key field in the browser rather than the locative information. Such entry is then referenced in accordance with a venue's matching name stored in the data base table of the invention's venues and facilities.

Block 104 represents: an “activity selection” step wherein a user, via the interface, enters at least some information as to the activity to occur at the venue. At 104, user input is required for integration of data workflow required to evaluate the cost of insurance. The “Activity” is subsequently displayed on the insurance policy and insurance certificate. The Activity is the condition of involvement that the user of the facility is conducting to which their insurance underwrites. Depending on the venue, certain activities may or may not be available for choosing by the venue or facility user. Therefore, the venue's available Activities are maintained within the Venue Database tables.

Block 105 (activity rating) represents a step wherein the user's indicated Activity selected at 104 is weighted and considered and thereby the result is a rate expressed in currency (for example dollars) which is then carried forward and used to indicate the purchase price of the policy of insurance

Block 106 represents the “duration selection” step wherein a user, via the interface enters at least Duration Selection and illustrates that user input is required for integration of data workflow required to evaluate the cost of insurance. The Duration is subsequently displayed on the insurance policy and insurance certificate. The Duration is preferably the time during which the user occupies the facility. Depending on the venue, certain Durations may or may not be available for choosing by the venue or facility user. Therefore, the venue's available Durations are maintained within the Venue Database tables. Further, this section also requires the user input for a field relating to the Effective Date, the user input required for integration of data workflow required to be displayed on the insurance policy and insurance certificate. The Effective Date is the time and calendar date in which the insurance policy becomes enforced and considered to take effect.

Further, this section also requires the user input in a field relating to the Expiry Date, the user input required for integration of data workflow required to be displayed on the insurance policy and insurance certificate. The Expiry Date is the time and calendar date in which the insurance policy becomes no longer in force and considered no longer in effect.

Block 107 (rating duration) represents a step wherein the user's indicated duration 106 is weighted and considered and thereby the result is a rate expressed in currency (for example dollars) which is then carried forward and used to indicate the purchase price of the policy of insurance.

Block 108 (limit selection) represents the “limit selection” step wherein a user's input for integration of data workflow is used to evaluate the cost of insurance. The Limit Selection is subsequently displayed on the insurance policy and insurance certificate. Simply put, the Limit Selection is the maximum benefit an insurance company will pay a policyholder if/when an insured event occurs. Depending on the venue, certain Minimum Limits may or may not be required and therefore may or may not be displayed for choosing by the venue or facility user. Therefore, the venue's Minimum Limits are stored and maintained within Venue Database tables. Further, user inputs a field relating to Named Insured, further illustrating how user input is used for integration of date workflow required to be displayed on the insurance policy and subsequent insurance certificate. The Named Insured is the policy rights holder.

Block 109 (limit rating) represents a step wherein the user's indicated limit selection shown at block 108 is weighted and assessed. Thereafter, the result is a rate expressed in currency (for example) dollars which is then carried forward and used to indicate the purchase price of the policy of insurance.

Block 110 (order creation) illustrates the step wherein previous workflow data and analysis occurs, and wherein responses are weighed and assessed so that the system can then respond with policy issuance, policy creation, policy purchase, policy payment and policy payment confirmation.

Block 111 (policy issuance) represents a step wherein policy payment confirmation is received and whereby the processed results are provided as an electronic document of insurance referred to as a Certificate of Insurance.

Block 112 represents the delivery of the Certificate Delivery and wherein, it is preferably delivered via electronic means so as to provide the user of municipal venues and privately owned facilities sufficient evidence that insurance is in effect during and for the user's activities while occupying municipal venues and privately owned facilities.

Block 113 represents the venue/facility, and showing that the method and system of the invention makes available via electronic documentation sent to the venue or facility or equipment “source” (for example to owner or manager or administrator of such a venue or such equipment) such evidence confirming that the insurance is in effect during and for i) the user's activities while occupying municipal venues and privately owned facilities and/or ii) the user's use of equipment.

Block 114 represents conveyance to the user of an electronic document (relating to the venue or facility or equipment) which is evidence that insurance is in effect during and for the user's activities while occupying municipal venues and privately owned facilities or while using the equipment. The end product, namely a Certificate of Insurance, is generated online by the method and system of the invention without intervention of a person other than the user, at an interface on a device. Heretofore, while it is known to prepare and deliver to a user an online automatic insurance quotation, the creation and delivery of a binding policy and Certificate of Insurance has not.

Block 115 represents conveyance to a broker of record of an electronic document (sent, for example, via electronic email delivery) which document is evidence that insurance is in effect during and for the user's activities while occupying municipal venues and privately owned facilities or while using the equipment.

Block 116 represents a User Account through which a user, employing a method and system of the invention, has access to via (for example a web browser interface) links or data showing historical representation of purchased Certificates of Insurance that the user has purchased, which links or data are made available via electronic delivery as well as retrievable through the user's on-line document storage system so as to provide the user of municipal venues and privately owned facilities or of equipment sufficient evidence that insurance is in effect during and for the user's activities while occupying municipal venues and privately owned facilities or while using the equipment.

Block 117 represents a Certificate Storage, accessible electronically via electronic archival storage software which makes available a searchable listing of some or all certificates, purchased by the User, which may be displayed via links or other data representation.

Block 118 illustrates a certification retrieval and removal means wherein a user may make available (to third parties including the venue administrator) via electronic means, a downloadable file which can be sent to the Certificate Delivery routines found in block 112. Certificates may be transmitted and re-transmitted as required.

FIG. 2 is a schematic block flow diagram of a system shown generally at 80 (in accordance with some demonstrative embodiments of the invention) and includes Venue Database 201. Venue Database 201 comprises information which may be periodically enhanced and updated based on information received from one or more of: venue operators, venue owners, insurance providers, users, and administrators. It is to be understood that, with regards to the rental of equipment, Venue Database may be referred interchangeably as Equipment Database. In the alternative, data relating to a venue and equipment used therein may be stored in one database, called Venue Database.

With reference to FIG. 2, administrator 200 is the person responsible for creating and maintaining the venues and all associated and related parameters which are compiled and/or listed in a database used in the system of the invention. The administrator logs into the online system and can create a new venue or lookup existing venues for further review and modification so that the venue can be available for discovery by the venue or facility user. Without limiting the scope of an administrator's role, such person will be able among other items, to create, modify and review various entries in the Venue Database tables and connect and associate Activities, Durations, Limits and Carriers as noted in blocks 202, 203, 204, 205, and 206.

Venue database is illustrated at 201. Each venue in the system contains field data which is used for display when a user accesses the venue via web browser when requiring the purchase of an insurance policy for that venue. In relation to the policy, the venue database may comprise one or more of the following field data set which is administered via a system administrator:

Additional Insured/Loss Payee: illustrates the data lookup and data collection database table relating to the selected venue so that the insurance policy and insurance certificate include, at the request of the venue's administrator, related legal entities, agents and others to be displayed on the insurance policy and insurance certificates. Additional Insureds is a person(s) or organization(s) that enjoys the benefits of being insured under the insurance policy. Depending on the venue, certain Additional Insureds are required to be displayed to the venue or facility user. A Loss Payee is the business that receives the cash settlement from the insurance underwriter for equipment that is lost or damaged. Therefore, the venue's Additional Insureds and Loss Payees are maintained within the Venue Database tables.

Venue Address and/or GeoLocation positioning: illustrates the administrative input required for integration of data workflow required to evaluate the location of the venue presented to the venue or facility user. The Venue Address & GeoLocation is subsequently displayed on the user interface by way of text and image map as to indicate the physical location of the venue. The venue's address and GeoLocation is maintained within the Venue Database tables.

Minimum Liability Limit Required: Illustrates the data lookup and data collection database table relating to the selected venue so that the insurance policy and insurance certificate include, at the request of the venue's administrator a minimum allowable Limit of Insurance. The values are conventionally, although not always, expressed in “millions of dollars”. Depending on the venue, certain Minimum Liability Limits are required to be displayed to the venue or facility user. Therefore, the venue's Minimum Liability Limit Required is maintained within the Venue Database tables.

Block 202 represents Activities and illustrates the user input required for integration of data workflow required to evaluate the cost of insurance. The Activity is subsequently displayed on the insurance policy and insurance certificate. The Activity is the condition of involvement that the user of the facility is conducting to which their insurance underwrites. Depending on the venue, certain activities may or may not be available for choosing by the venue or facility user. Therefore, the venue's available Activities are maintained within the Venue Database tables. In addition, each activity contains a sub-table of related lookup data which is capable of displaying an insurance underwriter for inclusion and display on the insurance policy so as to provide the means to provide multiple carriers of insurance and also provides the ability to select a carrier based on the individual activity that the user is engaged.

Block 203 represents Duration and illustrates the user input required for integration of data workflow required to evaluate the cost of insurance. The Duration is subsequently displayed on the insurance policy and insurance certificate. The Duration is the time during which the user occupies the facility. Depending on the venue, certain Durations may or may not be available for choosing by the venue or facility user. Therefore, the venue's available Durations are maintained within the Venue Database tables.

Block 204 represents Limits and illustrates the data lookup and data collection database table relating to the selected venue so that the insurance policy and insurance certificate include, at the request of the venue's administrator a Limit of Insurance and thereby a result is a rate expressed in dollars which is then carried forward and used to indicate the purchase price of the policy of insurance.

Block 205 represents Actuarial functions and illustrates the collection of various data points used to determine the impact of risk and uncertainty. As described further herein, such data collection can be used to mathematically evaluate the probability of events and quantify the contingent outcomes in order to minimize the impacts of financial losses associated with events. The data points used in such calculations include, but are not limited to: historical loss runs of the venue, loss experience by user type, losses collected per activity, trends of damage likely per location type, and increases of likelihood of loss per duration. For example; historically high-risk data collection points will increase the cost of insurance automatically.

Block 205 represents the User Interface, which, among other things, provides user access to the system via web browser as demonstrated in block 101 and blocks 102 through 118.

Any of the computing servers and devices described in connection with the methodology flow 90 and system 80 (for example, user device comprising user interface 206, administrator device 200 and server hosting venue Database 201) may access information in one or more databases. The databases, including Venue Database 201 may include, for example, information about customers, previous insurance policies on a venue or for equipment, and/or insurance policy components. Moreover, any of the servers and/or devices may exchange information via a communication network. These devices (and any of the other devices described herein) could be associated with, for example, a server, a PC, a mobile or laptop computer, or any other appropriate storage and/or communication device adapted to exchange information via a web site and/or a communication network. As used herein, devices may exchange information via any communication network, such as a Local Area Network (LAN), a Metropolitan Area Network (MAN), a Wide Area Network (WAN), a proprietary network, a Public Switched Telephone Network (PSTN), a Wireless Application Protocol (WAP) network, a Bluetooth network, a wireless LAN network, and/or an Internet Protocol (IP) network such as the Internet, an intranet, or an extranet. Note that any servers and/or devices described herein may communicate via one or more such communication networks.

Ratings Engines:

One aspect of the method and system of the present invention relates to a ratings engine. A base ratings engine operates based upon a collection of input variables received from various triggers within a core [venue and/or equipment] web interface module; and a series of data entry points trigger the weighting scale as given attributes within the ratings tree (as navigated by the user).

By way of the on-line binding system application for venue insurance via an on-line system web server, described here, a user answers the questions, and such answers comprise information selected from the group consisting of: venue and location, activity to be occurring at venue, duration of activity, effective date of policy, and expiry of policy (“attributes”). A database is searched for attributes and rating information is received from a rating engine relating to at least one of: desired venue and location, activity to be undertaken at desired venue, duration of activity and maximum benefits payable upon the occurrence of an insured event (limit selection). Thereafter, using the rating information, i) a quote for an insurance policy is calculated and ii) insurance terms are devised thereby to create and issue insurance policy for the user, both i) and ii) without interaction with an insurance agent or customer service representative (CSR).

Preferably, for a venue, a static ratings table is used to generate rating information.

Preferably, wherein a venue rating (V) using a static ratings table is cross-referenced to both the activity and the duration (D) to generate a base rate (BR), the base rate is multiplied by an insurance limit factor (L) to generate a base sum (BS), which base sum is then offset by adding actuarial loss data for at least one of losses for the activity (AA), losses for the venue (AV), losses for the user by age (AU), losses for the duration (AD) by formula:

TABLE 1

| Venue Type | Ice Rink | $5 | | | |
|---|---|---|---|---|---|
| | Gymnasium | $3 | | | |
| | Soft Seat Theatre | $7 | | | |
| | Playing Field | $4 | | | |
| | Meeting Rooms | $2 | | | |
| Activity Base | | | | | 21+ days |
| Rates | | 1 day | 2-6 days | 7-21 days | (seasonal) |
| | Hockey | $7 | $14 | $28 | $196 |
| | Basketball | $7 | $14 | $28 | $196 |
| | Soccer | $7 | $14 | $28 | $196 |
| | Baseball | $7 | $14 | $28 | $196 |
| | Music Concerts | $10 | $20 | $40 | $280 |
| | Memorials | $10 | $20 | $40 | $280 |
| | Conventions | $15 | $30 | $60 | $420 |
| | Business | $9 | $18 | $36 | $252 |
| | Seminars | | | | |
| Insurance Limit Factor | | $2,000,000 | | Base Rate | |
| | | $3,000,000 | | Base × 30% | |
| | | $5,000,000 | | Base × 60% | |
| Acturial | | 1 | 2 | 3 | 4 or more |
| | Losses at | 0.02 | 0.0378 | 0.0548 | uninsurable |
| | venue | | | | |
| | Losses by user | 0.03 | 0.054 | 0.0782 | uninsurable |
| | age | | | | |
| | Losses by | 0.03084 | 0.055512 | 0.0803896 | uninsurable |
| | activity | | | | |
| | Losses by | 0.0320736 | 0.05773248 | 0.083605184 | uninsurable |
| | duration | | | | |

By way of the on-line binding system application for equipment insurance via an on-line system web server, described here, a user answers questions relating to equipment to be insured using the on-line binding system application via an on-line system web server, and wherein said answers to the questions comprise information selected from the group consisting of: type of equipment, activity to be performed using equipment, venue and location, duration of equipment use, effective date of policy, and expiry of policy (“attributes”). Thereafter, attributes are searched in a database, rating information is received from a rating engine relating to at least one of: equipment type, activity, duration of use of equipment and maximum benefits payable upon the occurrence of an insured event (limit selection) and using this rating information, i) a quote is calculated for an insurance policy and ii) insurance terms are generated thereby to create and issue insurance policy for the user, both i) and ii) occurring without interaction with an insurance agent or customer service representative (CSR).

Preferably, for equipment, a static ratings table is used to generate rating information.

Preferably, an equipment rating (V) using a static ratings table is multiplied by a factor (weight) for the activity (V*A) to create a loaded weight, and the loaded weight is multiplied by a replacement cost of the equipment and then divided by one year (365 days) to determine a daily rate of insurance (BS) which daily rate is then offset by adding actuarial loss data for at least one of losses for the activity (AA), losses for the venue (AV), losses for the user by age (AU), losses for the duration (AD) by formula:

((V*A)*L/365)+(AV+AU+AA+AD)*D

wherein D is duration of equipment use, therein to generate a quote for an insurance policy.

Table 2 illustrates an example of ranges of selected variables and factors for use in a fully automated method of insuring equipment for rental, in accordance with the present invention. A database comprises a plurality of such factors and attributes in a lookup table:

TABLE 2

| Equipment Type | Camera | $1.75 | | | |
|---|---|---|---|---|---|
| | Music Gear | $1.50 | | | |
| Activity | Camera Rental | 1.1 | | | |
| | Music Gear Rental | 1 | | | |
| Insurance Limit | (value from user) | | | | |
| Actuarial | | 1 | 2 | 3 | 4 or more |
| | Losses at venue | 0.02 | 0.0378 | 0.0548 | Uninsurable |
| | Losses by user age | 0.03 | 0.054 | 0.0782 | Uninsurable |
| | Losses by | 0.03084 | 0.055512 | 0.0803896 | Uninsurable |
| | equipment type | | | | |
| | Losses by duration | 0.0320736 | 0.05773248 | 0.083605184 | uninsurable |

The base ratings engine is a collection of input variables received from various triggers within the core [venue] web interface module including those inputs from user; wherein a series of data entry points trigger the weighting scale as given attributes within the ratings tree as navigated by the user.

Input Variables (examples)

What type of Venue?

What type of Activity?

How long is this policy? (Duration)

Limit Required (underwriting risk)

Identify Variable and Calculation of Risk

Venue

Type [variables]+|[tax variable]

Activity

Risk Factor [×]|Number of People [×]|Host Liquor [%]

Duration

Time [×]

Risk

Liability [%]

Prepare Quotation

Basic formula results in total cost of insurance

For example, Price per Head, Price Flat, Fees & Taxes.

Sub Logic:

The system of the invention comprises a searching means which comprises at least one of i) a venue selection module and ii) an equipment selection module through which either or both of the desired venue and the desired equipment is identified and located (for example, by keywords or via a geographic search).

Preferably, the venue selection module comprises a database of venues through which the desired venue may be located and identified and through which insurance-relevant data and triggers related to the desired venue may be appropriated. In this context, insurance-relevant data comprises additional insured requirements, loss history, activities allowed at venue, license agreements to which venue or user bound, square footage , capacity, alcohol licensing, minimum indemnity and limits.

Preferably, the equipment selection module comprises a database of equipment which is desired to be rented may be located and/or identified and through which insurance-relevant data and triggers related to the desired equipment may be appropriated. In this context, insurance-relevant data comprises the type of equipment and replacement value for the equipment.

A base ratings engine operates based upon a collection of input variables received from various triggers within a core [venue and/or equipment] web interface module; and a series of data entry points trigger the weighting scale as given attributes within the ratings tree (as navigated by the user).

The following examples of sub-logic or argumentative data may be used in rating, in accordance with the method of the invention, at one or more trigger points:

History (loss run)

User Rating (weight)

Likelihood (index)

Commission (%)

Activity Rate Class (x factor)

Trends of risk (tag)

Min. Requirement (venue selected)

Approval of activity/event (venue selected)

Venue's geo tags (location & info)

With the scope of the invention, the method (and system by which method is implemented) provides a bridge to transform a basic request from a user for venue and/or equipment insurance into a fully bound policy and certificate of insurance, delivered electronically to one or more of the user, the venue or equipment owner, and the insurance company (or underwriter) all without the intervention by or communication with an insurance agent or broker. The method and system acquires data from the user, searches attributes of the venue and/or equipment from a database or repository of information relating to the venue and/or equipment, receives rating information from a rating engine relating to venue and/or equipment, calculates insurances terms, creates a quote, binds a policy and creates a certificate of insurance (the end product and result of data transformation).

General Comments on Types of Venue/Event Insurance

Participant General Liability Coverage

This type of coverage provides liability protection for not only third party spectators, but also participants at a user's event. If a user is coaching a baseball team, in charge of a 5K race, operating a summer camp or teaching a dance class; this is the type of coverage a user will need.

General Liability Coverage

This is the basic type of coverage. General Liability provides coverage for the named insured against claims from third party individuals. Spectators at sporting events, concerts, food fairs or renting a venue for a party are a few examples of how General Liability Coverage can be applied.

Excess Accident Medical Coverage

Excess Accident Medical coverage pays in excess of the primary medical coverage any medical bills/expenditures that an injured participant suffers. If the injured party has no primary health insurance, or the sustained injury is only covered partially by their primary health insurance, Excess Accident Medical limits can then be accessed to help pay for medical costs (subject to the deductible).

Excess General Liability Coverage

When the standard Participant and General Liability limits do not equal the required amounts set by a venue or league, a user has the option of purchasing Excess General Liability. Also known as Umbrella coverage, there are an assortment of increments which can be added in addition to the primary General Liability limits. Excess General Liability conventionally follows the same form and exclusions as the primary liability insurance.

Host Liquor and Liquor Legal Liability

If alcohol will be served at a user's event, there are often two types of coverage: Host Liquor and Liquor Legal. For events where there's a cash bar or the price of admission contains a certain number of free drinks; a user will need to purchase Liquor Legal Liability. If a user is hosting an event where alcohol is being dispensed at no charge (i.e. Open Bar), the venue is handling the sales or a user are receiving no profits from said sales, then Host Liquor coverage may be appropriate.

Computing Systems

The systems and methods described herein rely on a variety of computer systems, networks and/or digital devices for operation. As will be appreciated by those skilled in the art, computing systems and web-based cross-platforms include non-transitory computer-readable storage media for tangibly storing computer readable instructions. In order to fully appreciate how this preferably web-based cross-platform application and system operates an understanding of suitable computing systems is useful and is provided herein.

In one aspect, a computer system (or digital device), which may be understood as a logic apparatus adapted and configured to read instructions from media and/or network port, is connectable to a server and can have a fixed media. The computer system can also be connected to the Internet or an intranet. The system includes central processing unit (CPU), disk drives, and optional input devices, such as a keyboard and/or mouse and optional monitor. Data communication can be achieved through, for example, communication medium to a server at a local or a remote location. The communication medium can include any suitable means of transmitting and/or receiving data. For example, the communication medium can be a network connection, a wireless connection or an Internet connection.

It is envisioned that data relating to the present disclosure can be transmitted over such networks or connections. The computer system can be adapted to communicate with a participant and/or a device used by a participant. The computer system is adaptable to communicate with other computers over the Internet, or with computers via a server. Each computing device (including mobile devices) includes an operating system (OS), which is software, that consists of software programs and data that runs on the devices, manages the device hardware resources, and provides common services for execution of various application software. The operating system enables an application program to run on the device.

As will be appreciated by those skilled in the art, a computer readable medium stores computer data, which data can include computer program code that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable storage media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

A user launches an app created by an app creator and downloaded to the user's mobile device to view digital content items and can connect to a front end server via a network, which is typically the Internet, but can also be any network, including but not limited to any combination of a LAN, a MAN, a WAN, a mobile, wired or wireless network, a private network, or a virtual private network. As will be understood a very large numbers (e.g., millions) of users are supported and can be in communication with the website via an app at any time. The user may include a variety of different computing devices.

Application delivery platform can be implemented entirely in hardware and/or a combination of hardware and/or software in execution. Further, application delivery platform can be incorporated within and/or associated with other compatible components. Additionally, application delivery platform can be, but is not limited to, any type of machine that includes a processor and/or is capable of effective communication with network topology and/or cloud. Illustrative machines that can comprise application delivery platform can include desktop computers, server class computing devices, laptop computers, notebook computers, Tablet PCs, consumer and/or industrial devices and/or appliances, hand-held devices, and the like.

Network topology and/or cloud can include any viable communication and/or broadcast technology, for example, wired and/or wireless modalities and/or technologies can be utilized to effectuate the claimed subject matter. Moreover, network topology and/or cloud 104 can include utilization of Personal Area Networks (PANs), Local Area Networks (LANs), Campus Area Networks (CANs), Metropolitan Area Networks (MANs), extranets, intranets, the Internet, Wide Area Networks (WANs)—both centralized and/or distributed—and/or any combination, permutation, and/or aggregation thereof. Furthermore, as those skilled in the art will appreciate and understand various data communications protocols (e.g., TCP/IP, Ethernet, Asynchronous Transfer Mode (ATM), Fiber Distributed Data Interface (FDDI), Fibre Channel, Fast Ethernet, Gigabit Ethernet, Wi-Fi, Token Ring, Frame Relay, etc.) can be utilized to implement suitable data communications.

Additionally application delivery server/platform may include a provisioning component that, based at least in part on input received from a portal component, can automatically configure and/or provision the various disparate mobile devices with appropriate applications.

It is to be appreciated that a store can be, for example, volatile memory or non-volatile memory, or can include both volatile and non-volatile memory. By way of illustration, and not limitation, non-volatile memory can include read-only memory (ROM), programmable read only memory (PROM), electrically programmable read only memory (EPROM), electrically erasable programmable read only memory (EEPROM), or flash memory. Volatile memory can include random access memory (RAM), which can act as external cache memory. By way of illustration rather than limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink® DRAM (SLDRAM), Rambus® direct RAM (RDRAM), direct Rambus® dynamic RAM (DRDRAM) and Rambus® dynamic RAM (RDRAM). Store 206 of the subject systems and methods is intended to comprise, without being limited to, these and any other suitable types of memory. In addition, it is to be appreciated that the store can be a server, a database, a hard drive, and the like.

Server Modules, Components, and Logic

Certain embodiments are described herein as including logic or a number of modules, components or mechanisms. A module, logic, component or mechanism (hereinafter collectively referred to as a “module”) may be a tangible unit capable of performing certain operations and is configured or arranged in a certain manner. In example embodiments, one or more computer systems (e.g. server computer system) or one or more components of a computer system (e.g., a processor or a group of processors) may be configured by software (e.g., an application or application portion) as a “module” that operates to perform certain operations as described herein.

In various embodiments, a “module” may be implemented mechanically or electronically. For example, a module may comprise dedicated circuitry or logic that is permanently configured (e.g., within a special-purpose processor) to perform certain operations. A module may also comprise programmable logic or circuitry (e.g., as encompassed within a general-purpose processor or other programmable processor) that is temporarily configured by software to perform certain operations.

Accordingly, the term “module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which modules or components are temporarily configured (e.g., programmed), each of the modules or components need not be configured or instantiated at any one instance in time. For example, where the modules or components comprise a general-purpose processor configured using software, the general-purpose processor may be configured as respective different modules at different times. Software may accordingly configure the processor to constitute a particular module at one instance of time and to constitute a different module at a different instance of time.

Modules can provide information to, and receive information from, other modules. Accordingly, the described modules may be regarded as being communicatively coupled. Where multiple of such modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation, and store the output of that operation in a memory device to which it is communicatively coupled. A further module may then, at a later time, access the memory device to retrieve and process the stored output. Modules may also initiate communications with input or output devices, and can operate on a resource (e.g., a collection of information).

Numerous embodiments are described in the present application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural and logical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

No embodiment of method steps or product elements described in the present application constitutes the invention claimed herein, or is essential to the invention claimed herein, or is coextensive with the invention claimed herein, except where it is either expressly stated to be so in this specification or expressly recited in a claim.

The invention can be implemented in numerous ways, including as a process, an apparatus, a system, a computer readable medium such as a computer readable storage medium or a computer network wherein program instructions are sent over optical or communication links. In this specification, these implementations, or any other form that the invention may take, may be referred to as systems or techniques. A component such as a processor or a memory described as being configured to perform a task includes both a general component that is temporarily configured to perform the task at a given time or a specific component that is manufactured to perform the task. In general, the order of the steps of disclosed processes may be altered within the scope of the invention.

The following discussion provides a brief and general description of a suitable computing environment in which various embodiments of the system may be implemented. Although not required, embodiments will be described in the general context of computer-executable instructions, such as program applications, modules, objects or macros being executed by a computer. Those skilled in the relevant art will appreciate that the invention can be practiced with other computing system configurations, including hand-held devices, multiprocessor systems, microprocessor-based or programmable consumer electronics, personal computers (“PCs”), network PCs, mini-computers, mainframe computers, mobile phones, personal digital assistants, smart phones, personal music players (like iPod) and the like. The embodiments can be practiced in distributed computing environments where tasks or modules are performed by remote processing devices, which are linked through a communications network. In a distributed computing environment, program modules may be located in both local and remote memory storage devices.

As used herein, the terms “computer” and “server” are both computing systems as described in the following. A computing system may be used as a server including one or more processing units, system memories, and system buses that couple various system components including system memory to a processing unit. Computing system will at times be referred to in the singular herein, but this is not intended to limit the application to a single computing system since in typical embodiments, there will be more than one computing system or other device involved. Other computing systems may be employed, such as conventional and personal computers, where the size or scale of the system allows. The processing unit may be any logic processing unit, such as one or more central processing units (“CPUs”), digital signal processors (“DSPs”), application-specific integrated circuits (“ASICs”), etc. Unless described otherwise, the construction and operation of the various components are of conventional design. As a result, such components need not be described in further detail herein, as they will be understood by those skilled in the relevant art.

The computing system includes a system bus that can employ any known bus structures or architectures, including a memory bus with memory controller, a peripheral bus, and a local bus. The system also will have a memory which may include read-only memory (“ROM”) and random access memory (“RAM”). A basic input/output system (“BIOS”), which can form part of the ROM, contains basic routines that help transfer information between elements within the computing system, such as during startup.

The computing system also includes non-volatile memory. The non-volatile memory may take a variety of forms, for example a hard disk drive for reading from and writing to a hard disk, and an optical disk drive and a magnetic disk drive for reading from and writing to removable optical disks and magnetic disks, respectively. The optical disk can be a CD-ROM, while the magnetic disk can be a magnetic floppy disk or diskette. The hard disk drive, optical disk drive and magnetic disk drive communicate with the processing unit via the system bus. The hard disk drive, optical disk drive and magnetic disk drive may include appropriate interfaces or controllers coupled between such drives and the system bus, as is known by those skilled in the relevant art. The drives, and their associated computer-readable media, provide non-volatile storage of computer readable instructions, data structures, program modules and other data for the computing system. Although computing systems may employ hard disks, optical disks and/or magnetic disks, those skilled in the relevant art will appreciate that other types of non-volatile computer-readable media that can store data accessible by a computer may be employed, such a magnetic cassettes, flash memory cards, digital video disks (“DVD”), Bernoulli cartridges, RAMs, ROMs, smart cards, etc.

Various program modules or application programs and/or data can be stored in the system memory. For example, the system memory may store an operating system, end user application interfaces, server applications, and one or more application program interfaces (“APIs”).

The system memory also includes one or more networking applications, for example a Web server application and/or Web client or browser application for permitting the computing system to exchange data with sources, such as clients operated by users and members via the Internet, corporate Intranets, or other networks as described below, as well as with other server applications on servers such as those further discussed below. The networking application in the preferred embodiment is markup language based, such as hypertext markup language (“HTML”), extensible markup language (“XML”) or wireless markup language (“WML”), and operates with markup languages that use syntactically delimited characters added to the data of a document to represent the structure of the document. A number of Web server applications and Web client or browser applications are commercially available, such as those available from Mozilla and Microsoft.

The operating system and various applications/modules and/or data can be stored on the hard disk of the hard disk drive, the optical disk of the optical disk drive and/or the magnetic disk of the magnetic disk drive.

A computing system can operate in a networked environment using logical connections to one or more client computing systems and/or one or more database systems, such as one or more remote computers or networks. The computing system may be logically connected to one or more client computing systems and/or database systems under any known method of permitting computers to communicate, for example through a network such as a local area network (“LAN”) and/or a wide area network (“WAN”) including, for example, the Internet. Such networking environments are well known including wired and wireless enterprise-wide computer networks, intranets, extranets, and the Internet. Other embodiments include other types of communication networks such as telecommunications networks, cellular networks, paging networks, and other mobile networks. The information sent or received via the communications channel may, or may not be encrypted. When used in a LAN networking environment, the computing system is connected to the LAN through an adapter or network interface card (communicatively linked to the system bus). When used in a WAN networking environment, the computing system may include an interface and modem (not shown) or other device, such as a network interface card, for establishing communications over the WAN/Internet.

In a networked environment, program modules, application programs, or data, or portions thereof, can be stored in the computing system for provision to the networked computers. In one embodiment, the computing system is communicatively linked through a network with TCP/IP middle layer network protocols; however, other similar network protocol layers are used in other embodiments, such as user datagram protocol (“UDP”). Those skilled in the relevant art will readily recognize that these network connections are only some examples of establishing communications links between computers, and other links may be used, including wireless links.

While in most instances the computing system will operate automatically, where an end user application interface is provided, an operator can enter commands and information into the computing system through an end user application interface including input devices, such as a keyboard, and a pointing device, such as a mouse. Other input devices can include a microphone, joystick, scanner, etc. These and other input devices are connected to the processing unit through the end user application interface, such as a serial port interface that couples to the system bus, although other interfaces, such as a parallel port, a game port, or a wireless interface, or a universal serial bus (“USB”) can be used. A monitor or other display device is coupled to the bus via a video interface, such as a video adapter (not shown). The computing system can include other output devices, such as speakers, printers, etc.

The present methods, systems and articles also may be implemented as a computer program product that comprises a computer program mechanism embedded in a computer readable storage medium. For instance, the computer program product could contain program modules. These program modules may be stored on CD-ROM, DVD, magnetic disk storage product, flash media or any other computer readable data or program storage product. The software modules in the computer program product may also be distributed electronically, via the Internet or otherwise, by transmission of a data signal (in which the software modules are embedded) such as embodied in a carrier wave.

For instance, the foregoing detailed description has set forth various embodiments of the devices and/or processes via the use of examples. Insofar as such examples contain one or more functions and/or operations, it will be understood by those skilled in the art that each function and/or operation within such examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

In addition, those skilled in the art will appreciate that the mechanisms taught herein are capable of being distributed as a program product in a variety of forms, and that an illustrative embodiment applies equally regardless of the particular type of signal bearing media used to actually carry out the distribution. Examples of signal bearing media include, but are not limited to, the following: recordable type media such as floppy disks, hard disk drives, CD ROMs, digital tape, flash drives and computer memory; and transmission type media such as digital and analog communication links using TDM or IP based communication links (e.g., packet links).

Further, in the methods taught herein, the various acts may be performed in a different order than that illustrated and described. Additionally, the methods can omit some acts, and/or employ additional acts. As will be apparent to those skilled in the art, the various embodiments described above can be combined to provide further embodiments. Aspects of the present systems, methods and components can be modified, if necessary, to employ systems, methods, components and concepts to provide yet further embodiments of the invention. For example, the various methods described above may omit some acts, include other acts, and/or execute acts in a different order than set out in the illustrated embodiments.

These and other changes can be made to the present systems, methods and articles in light of the above description. In general, in the following claims, the terms used should not be construed to limit the invention to the specific embodiments disclosed in the specification and the claims, but should be construed to include all possible embodiments along with the full scope of equivalents to which such claims are entitled. Accordingly, the invention is not limited by the disclosure, but instead its scope is to be determined entirely by the following claims.

While certain aspects of the invention are presented below in certain claim forms, the inventors contemplate the various aspects of the invention in any available claim form. For example, while only some aspects of the invention may currently be recited as being embodied in a computer-readable medium, other aspects may likewise be so embodied.

### EXAMPLES

### Example 1

### Venue Use Ratings Example ‘A’

A user, in real time wishes to acquire rental of a hockey rink for a Christmas Party. User engages with an application on a mobile device through which he/,slue can be provided with a real-time, on-line bound policy for a venue. User interacts via a graphical user interface and answers a plurality of questions relating to at least one of the venue to be insured, by the on-line binding system application via an on-line system web server, wherein said answers to the questions comprises information selected from the group consisting of: venue and location, activity to be occurring at venue, duration of activity, effective date of policy, and expiry of policy (“attributes”). The user may simply search the venue by its name or its location or by any combination of search parameters.

To determine the cost of insurance for users occupying the rink while playing hockey, a static ratings table for venue types is employed, providing for example, that ice rinks carry a weight of $5 per user. The Activity (Hockey) is cross-referenced with the length of occupancy (number of days) to output a flat fee of $7 and these are combined for a total base rate of $12 for hockey at an ice rink. The limit amount of indemnity will cause the base rate to be calculated as a multiplication factor. So if we choose $2,000,000 Limit, the base rate is then multiplied by 1.2 to determine the Base Sum. Finally, we then offset the Base Sum by adding the Actuarial loss data performance of the activity to sum a total cost of insurance.

| Venue Selection Rates Table: (V) | |
|---|---|
| [Ice Rink Selected by user] | $5.00 |
| Activity Rates Table (A) | |
| [Hockey Selected by user] | |
| Duration (D) cross reference V~A | |
| [1 day Selected by user] | $7.00 |
| (V + D) Base Rate (BR) | $12.00 |
| Insurance Limit Factor (L) | |
| [$2,000,000 Selected by user] (BR) * 1.2 | |
| Base Sum (BS) | $14.40 |
| Actuarial (A) | |
| (AV) Losses at venue = 2 claims = 0.02 (base × 0.02) | $0.24 |
| (AU) Losses by user age = 0.03 (base × 0.03) | $0.36 |
| (AA) Losses for hockey = 0.04 (base × 0.04) | $0.48 |
| (AD) Losses for duration = 0.05 (base × 0.05 | $0.60 |
| (A) | $1.68 |
| Total (BS) + (A) | $16.08 |

This calculation may be expressed as:

(V+D)*L+(AV+AU+AA+AD)

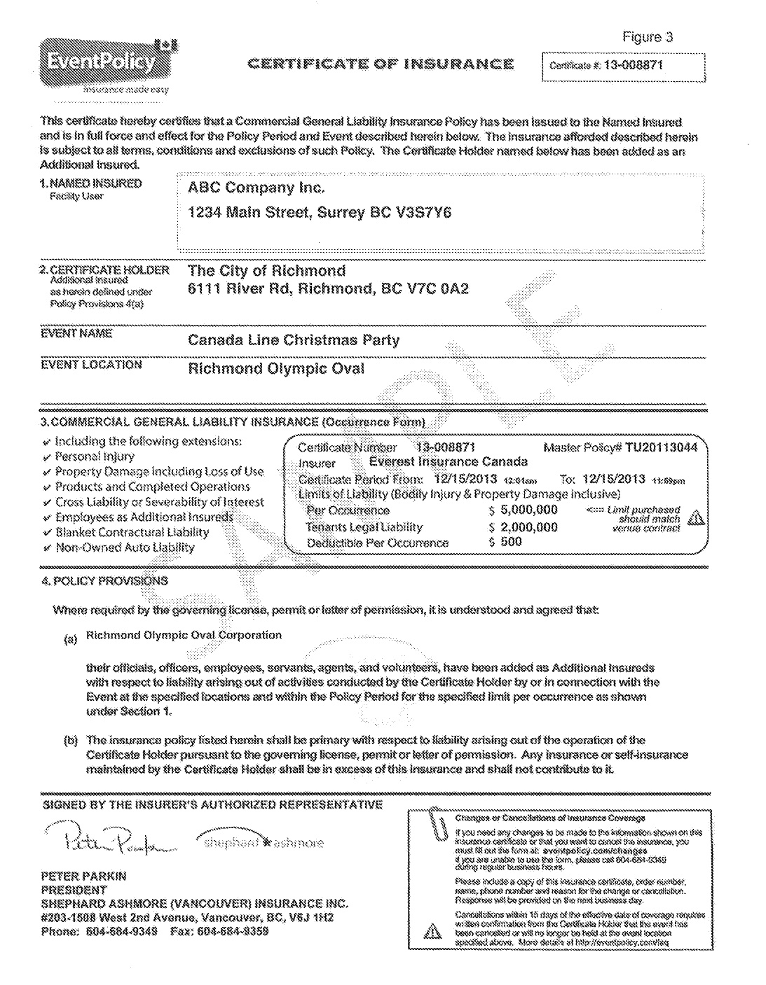

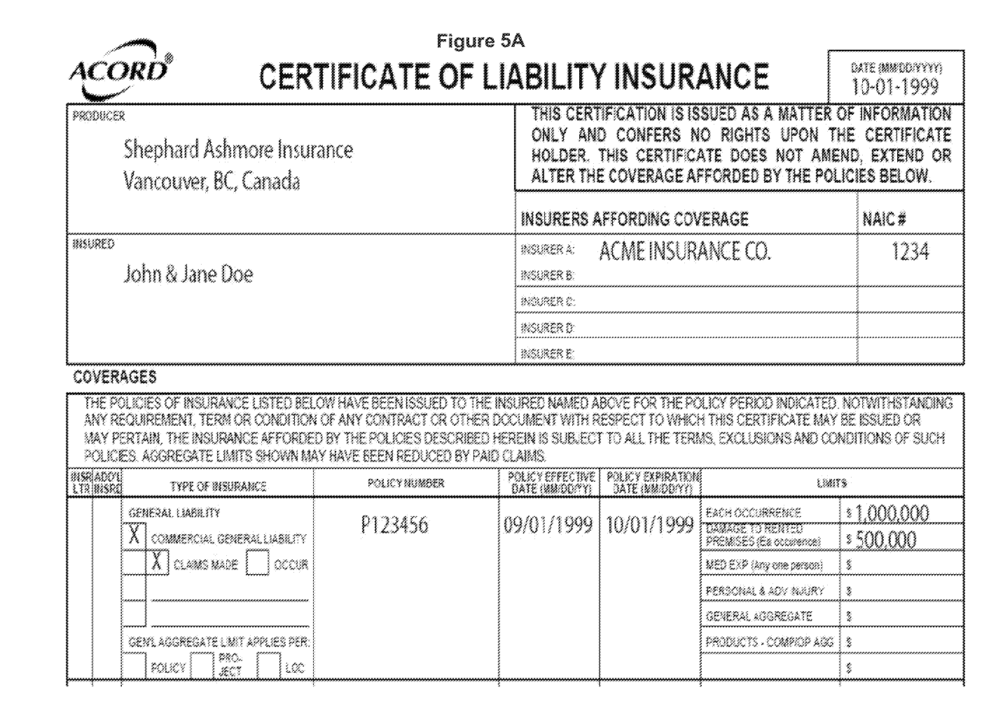

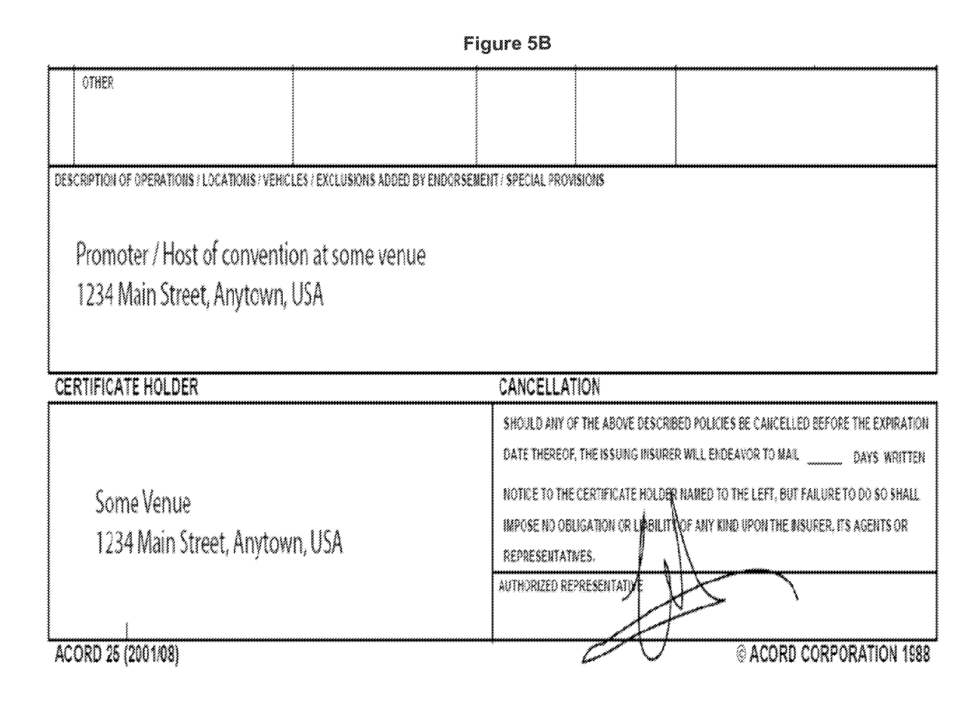

User is presented with the insurance quote, accepts the price and terms, pays and is provided with a Certificate of Insurance, accorded by the self-binding online method described herein. User has Certificate of Insurance pushed from the automatic online platform to his/her computing device. FIGS. 3 and 5 are examples of a Certificate of Insurance confirming acquisition of a binding insurance policy.

| Example 2--Venue Use Ratings Example “B” | |
|---|---|
| Venue Selection Rates Table: (V) | |
| [Community Centre Selected by user] | $8.00 |
| Activity Rates Table (A) | |
| [Basketball Selected by user] | |
| Duration (D) cross reference V~A | |
| [1 season Selected by user] | $117.00 |
| (V + D) Base Rate (BR) | $125.00 |
| Insurance Limit Factor (L) | |
| [$3,000,000 Selected by user] (BR) * 1.3 | |
| Base Sum (BS) | $162.50 |
| Actuarial (A) | |
| (AV) Losses at venue = 0 claims = 0.0 (base × 0.00) | $0.00 |
| (AU) Losses by user age = 0.05 (base × 0.05) | $8.1 |
| (AA) Losses for basketball = 0.02 (base × 0.02) | $3.25 |
| (AD) Losses for duration = 0.10 (base × 0.10 | $16.25 |
| (A) | $27.63 |
| Total (BS) + (A) | $190.13 |

This calculation may be expressed as;

(V+D)*L+(AV+AU+AA+AD)

receiving rating information from a rating engine relating to at least one of: desired venue and location, activity to be undertaken at desired venue, duration of activity and maximum benefits payable upon the occurrence of an insured event (limit selection) and calculating, using the rating information, i) a quote for an insurance policy and ii) insurance terms thereby to create and issue insurance policy for the user, both i) and ii) without interaction with an insurance agent or customer service representative (CSR).

### Example 3

### Equipment Use Ratings Example ‘A’

A user, in real time wishes to acquire rental of equipment/camera for use in making a music video. User engages with an application on a mobile device through which he/she can be provided with a real-time, on-line bound policy for such equipment. User interacts via a graphical user interface and answers a plurality of questions relating to equipment to be insured, by the on-line binding system application via an on-line system web server, wherein said answers to the questions comprises information selected from the group consisting of: type of equipment, activity to be performed using equipment, venue and location, duration of equipment use, effective date of policy, and expiry of policy (“attributes”).

To determine the cost of insurance for the equipment (under care and control of user, at a venue) i.e. while creating the video, a static ratings table for equipment types is preferably employed.

To determine the cost of insurance for users possessing equipment from a facility while it is under the care custody and control of the user, a static ratings table for equipment type I used, so for example, cameras carry a weight of $1.75 per $1000 of equipment (V). A multiplying factor (weight) is entered for the activity rental type (V*A), which loads the two weights together. This loaded rate is multiplied the replacement cost of equipment and then divided by 1 year (365) to determine the daily rate of insurance (BS). Additional weighting is added for Actuarial loss history and current user type and finally this number is multiplied by the actual number of days of use to determine the total cost of insurance.

| Equipment Type (V) | |
|---|---|
| [Cameras] | $1.75 |
| Activity (A) | |
| [Camera Rental] | 1.1 |
| Insurance Limit (L) | |
| [Camera cost $50,000] | $50,000 |
| V (1.75) * A (1.1) * L (50,000)/365 = Base Sum (BS) | $263.70 |
| Actuarial (A) | |
| (AV) Losses at venue = 1 claims = 0.1 (BS × 0.10) | $26.37 |
| (AU) Losses by user age = 0.05 (BS × 0.05) | $8.13 |
| (AA) Losses for cameras = 0.02 (BS × 0.02) | $3.25 |
| (AD) Losses for duration = 0.10 (BS × 0.10) | $16.25 |
| (AV + AU + AA + AD) = A Actuarial Sum (A) | $54.00 |
| Duration (D) | |
| [2 days selected by user] | 2 |
| (BS (263.70) + A (54.00)) * D (2) Total Cost | $527.40 |

Expression: ((V*A)*L/365)+(AV+AU+AA+AD)*D

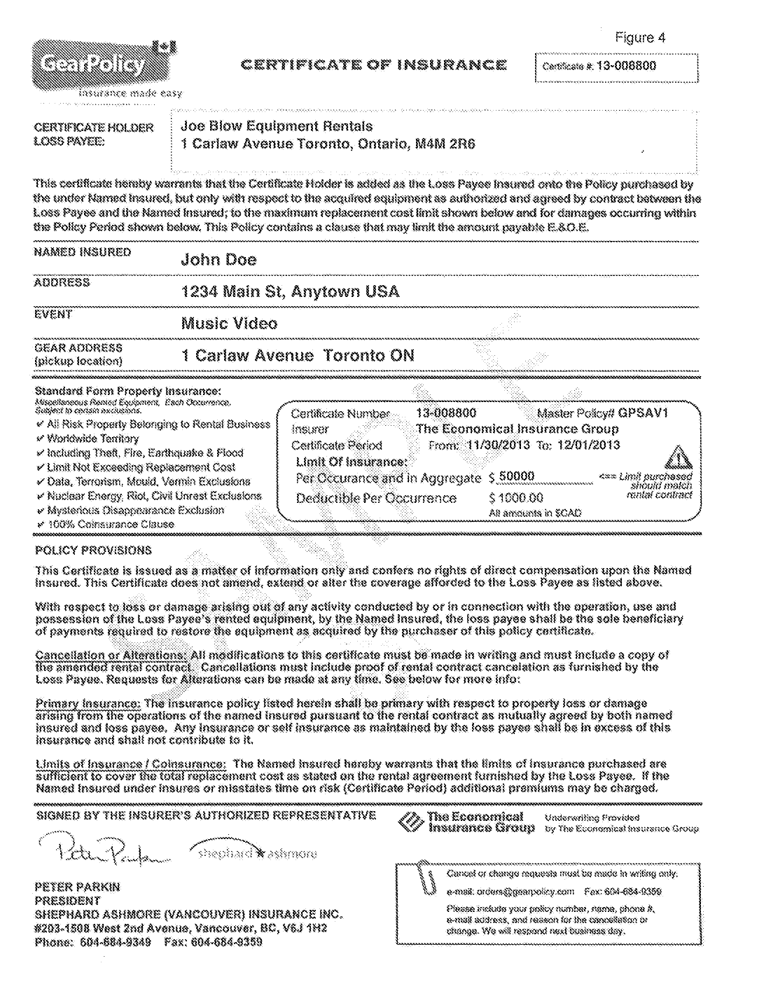

User is presented with the insurance quote, accepts the price and terms, pays and is provided with a Certificate of Insurance, accorded by the self-binding online method described herein. User has Certificate of Insurance pushed from the automatic online platform to his/her computing device. FIG. 4 is an example of a Certificate of Insurance confirming acquisition of a binding insurance policy.

We claim:

1. A system for creating an interactive, real-time, self-binding, insurance policy for an equipment rental dealer for a user of desired equipment, which comprises:
a) an electronic interface for the user;
b) a computer server for presenting to the user, via the electronic interface, prompted questions relating to the desired equipment and usage of the desired equipment from a specified location, and at least one of: activity to be undertaken with the desired equipment and the duration of use and to receive answers to the prompted questions;
c) a searchable base data store, rating engine store and searching module for said base data store;
d) a processor programmed to:
i) search attributes of the desired equipment in the searchable base data store, wherein the attributes are determined based on the answers to the prompted questions provided by the user, and automatically identify insurance data related to the desired equipment,
ii) automatically calculate rating information, using a static ratings table from a rating engine in the rating engine store relating to at least one of: type of equipment, location of the equipment, activity to be undertaken with the equipment, duration of rental contract and maximum benefits payable upon the occurrence of an insured peril,
iii) using the static ratings table, multiply an equipment rating (V) by a weight factor for the activity (V*A) to create a loaded weight, which loaded weight is multiplied by a replacement cost of the desired equipment and then divided by one year to determine a daily rate of insurance (BS), which daily rate is then offset by adding actuarial loss data for at least one of: losses for the activity (AA), losses for the desired equipment (AV), losses for the user by age (AU), losses for the duration (AD) by formula:
((V*A)*L/365)+(AV+AU+AA+AD)*D
wherein D is duration of equipment use, therein to generate a quote for an insurance policy,
iv) calculate, using the base data store information and rating information, a quote for an insurance policy and insurance terms,
v) automatically generate and issue the self-binding insurance policy, and
vi) automatically deliver electronically a certificate of insurance to the user and at least one of: the equipment rental dealer, an insurance company, an underwriter, and an additional insured, wherein
all of i)-vi) is performed, by the processor, without interaction with an insurance agent or customer service representative; and
e) a communications network between the electronic interface, the computer server, base data store, rating engine store and processor.

2. The system of claim 1 wherein the searching module comprises an equipment selection module which comprises a database of equipment through which the desired equipment is located and identified and through which insurance data related to the desired equipment is appropriated.

3. The system of claim 1 wherein the insurance data comprises information relating to previous usages of the equipment by other users.

4. The system of claim 1 wherein the searching module comprises an equipment selection module through which the desired equipment is located by at least a geographic search or by at least a characteristic of the equipment.

5. The system of claim 1 wherein the insurance data comprises at least one of equipment type and replacement values of said equipment.

6. A system of preparing for a user a real-time, on-line bound policy for equipment, at a venue, comprising: presenting to the user, by an on-line self-binding system application providing computer executable instructions executed by the system including:
a) receiving from the user at a computing device answers to questions relating to equipment to be insured, by the on-line self-binding system application via an on-line system web server, wherein said answers to the questions comprise information selected from the group consisting of: type of equipment, activity to be performed using the equipment, venue and location, duration of equipment use, effective date of policy, and expiry of policy;
b) searching attributes in a database, wherein the attributes are determined based on the answers to the questions; and
c) receiving rating information from a rating engine relating to at least one of: equipment type, duration of use of equipment, and maximum benefits payable upon the occurrence of an insured event and calculating, using the rating information:
i) a quote for an insurance policy and certificate of insurance, and
ii) insurance terms thereby creating and issuing an insurance policy for the user, both i) and ii) without interaction with an insurance agent or customer service representative.

7. A system of preparing for a user a real-time, on-line bound policy for equipment, at a venue, comprising: presenting to the user, by an on-line self-binding system application providing computer executable instructions executed by the system including:
a) receiving from the user at a computing device answers to a plurality of questions relating to equipment to be insured, by the on-line self-binding system application via an on-line system web server, wherein said answers to the plurality of questions comprise type of equipment, activity to be performed using the equipment, venue and location, duration of equipment use, effective date of policy, and expiry of policy;
b) searching attributes in a database, wherein the attributes are determined based on the answers to the plurality of questions; and
c) receiving rating information from a rating engine relating to at least one of: equipment type, duration of use of equipment, and maximum benefits payable upon the occurrence of an insured event and calculating, using the rating information:
i) a quote for an insurance policy and certificate of insurance, and
ii) insurance terms thereby creating and issuing an insurance policy for the user, both i) and ii) without interaction with an insurance agent or customer service representative.
